(19) United States
(12) Patent Application Publication
(10) Pub. No.: US 2025/0308498 A1
(43) Pub. Date: Oct. 2, 2025

(54) VEHICLE SOUND-ABSORBING DEVICE

(71) Applicant: NIFCO INC., Yokosuka-shi, Kanagawa (JP)

(72) Inventors: Naoki TSUTSUMI, Toyota-shi, Aichi (JP); Yoshiteru FUJITA, Kariya-shi, Aichi (JP); Sohei MIURA, Yokosuka-shi, Kanagawa (JP)

(21) Appl. No.: 18/867,007

(22) PCT Filed: May 30, 2023
(86) PCT No.: PCT/JP2023/020137

§ 371 Date: Nov. 19, 2024

(30) Foreign Application Priority Data
Jun. 2, 2022 (JP) 2022-090262

(51) Int. Cl. G10K 11/172; B60H 1/26; B60R 13/08

(52) U.S. Cl. CPC G10K 11/172; B60H 1/26; B60R 13/0815

(57) ABSTRACT

A vehicle sound-absorbing device is disposed in a ventilation space between a vehicle exterior and a vehicle interior. A communication opening through which the ventilation space communicates with a vehicle compartment is provided in the vehicle interior. The vehicle sound-absorbing device includes a shield plate configured to be connected to the vehicle exterior and the vehicle interior and thus divide the ventilation space into a first space in which the communication opening is disposed and a second space other than the first space; and a sound-absorbing structure configured to protrude from a first face of the shield plate toward the first space, the first face facing the first space.

### FIELD

The present invention relates to a vehicle sound-absorbing device to be disposed between a vehicle exterior and a vehicle interior.

### BACKGROUND

A vehicle interior dividing a vehicle compartment includes a ventilation opening penetrating through the vehicle interior. The ventilation opening includes a ventilator. While an air pressure in the vehicle compartment is stable, the ventilator blocks a through hole of the ventilator. When the air pressure in the vehicle compartment increases, the ventilator takes air out of the vehicle compartment through a space between the vehicle interior and the vehicle exterior.

Sound entering the space between the vehicle exterior and the vehicle interior diffuses between the vehicle exterior and the vehicle interior and then enters the vehicle compartment through the ventilation opening. A vehicle sound-absorbing device is disposed in a space between the vehicle exterior and the vehicle interior. The vehicle sound-absorbing device suppresses the diffusion of sound before the sound diffusing in the space between the vehicle exterior and the vehicle interior reaches the vehicle compartment.

An example of the sound-absorbing device is disposed between the vehicle interior and the vehicle exterior along a periphery of the ventilation opening. A material constituting the sound-absorbing device is a sound-absorbing material, such as an urethane pad or felt, or a composite material made of a laminated fiber material or a resin material on the sound-absorbing material. The sound-absorbing device suppresses sound entering into the space between the vehicle exterior and the vehicle interior from diffusing around the periphery of the ventilation opening (see, for example, Patent Literature 1).

### CITATION LIST

### Patent Literature

Patent Literature 1: Japanese Unexamined Patent Application Publication No. 2015-16809

### SUMMARY

### Technical Problem to be Solved by the Invention

On the other hand, the sound-absorbing device disposed along the periphery of the ventilation opening, however, extends over almost the entire periphery of the ventilation opening, and occupies a space for disposing the sound-absorbing material. A reduction of the space where the sound-absorbing device occupies improves ventilation of the space between the vehicle interior and the vehicle exterior in the periphery of the ventilation opening, and allows the vehicle compartment to be enlarged.

### Solution to Solve the Problem

According to an aspect of the present invention, provided is a vehicle sound-absorbing device configured to be disposed in a ventilation space between a vehicle exterior and a vehicle interior, the vehicle interior being provided with a communication opening through which the ventilation space communicates with a vehicle compartment, the vehicle sound-absorbing device including: a shield plate configured to be connected to the vehicle exterior and the vehicle interior and thus divide the ventilation space into a first space in which the communication opening is disposed and a second space other than the first space; and a sound-absorbing structure configured to protrude from a first face of the shield plate toward the first space, the first face facing the first space.

### BRIEF DESCRIPTION OF DRAWINGS

FIG. 1 is a sectional view illustrating a vehicle sound-absorbing device together with a vehicle exterior and a vehicle interior.

FIG. 2 is a perspective view of the vehicle sound-absorbing device as viewed from above.

FIG. 3 is an exploded perspective view illustrating the vehicle sound-absorbing device.

FIG. 4 is a perspective view of the vehicle sound-absorbing device as viewed from below.

FIG. 5 is a side view illustrating the vehicle sound-absorbing device.

FIG. 6 is a sectional view, as viewed from line 6-6 in FIG. 5.

FIG. 7 is a sectional view, as viewed from line 7-7 in FIG. 2.

FIG. 8 is a perspective view illustrating a vehicle sound-absorbing device according to an example different from the vehicle sound-absorbing device illustrated in FIGS. 1 to 7.

FIG. 9 is a graph illustrating calculation results of sound transmission loss.

### DESCRIPTION OF EMBODIMENTS

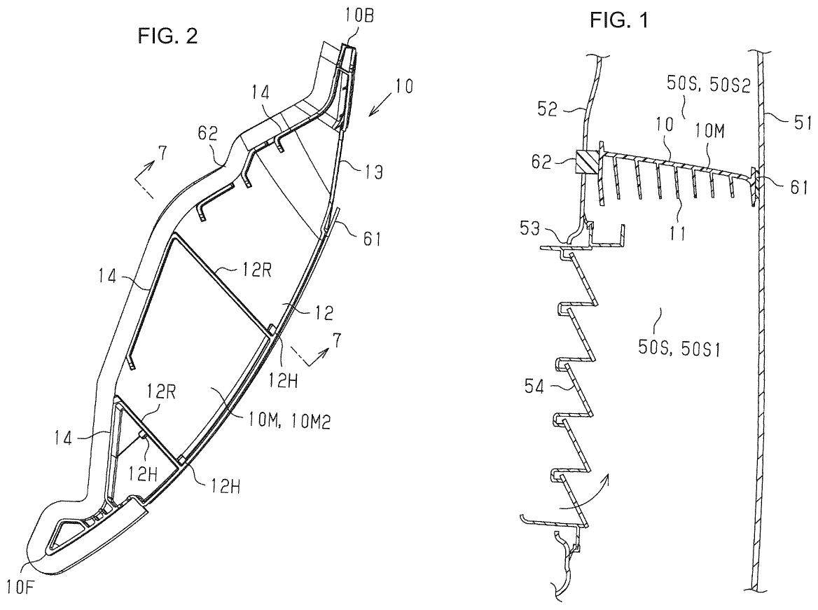

One embodiment will now be illustrated for a vehicle sound-absorbing device. A peripheral structure of the sound-absorbing device will be described with reference to FIG. 1.

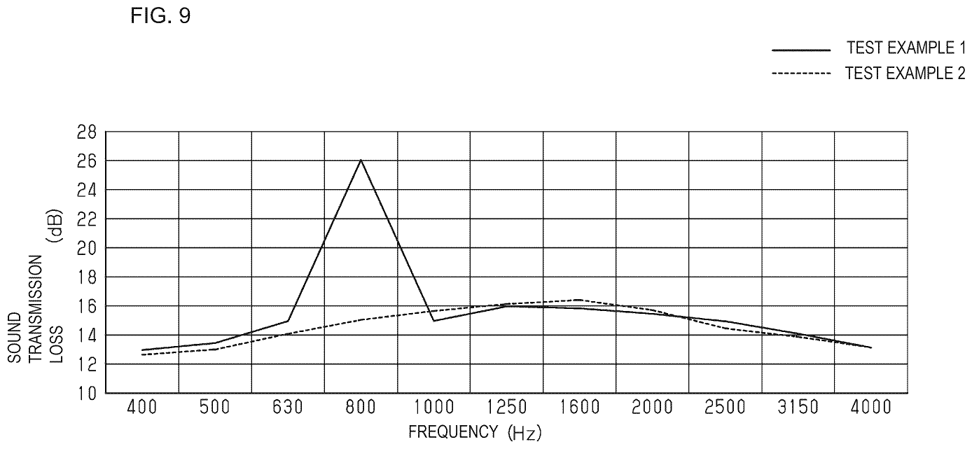

The vehicle sound-absorbing device will then be described with reference particularly to FIGS. 2 to 7. In addition, an operation of the vehicle sound-absorbing device will be described with reference to FIGS. 8 to 9. [Peripheral Structure]

As illustrated in FIG. 1, a rear bumper 51, which is an example of a vehicle exterior, and a rear side member 52, which is an example of a vehicle interior, define a ventilation space 50S. An upper end of the ventilation space 50S in FIG. 1 is defined by, such as a rear combination lamp. A lower end of the ventilation space 50S in FIG. 1 is open to the outside of the vehicle.

The rear side member 52 includes a communication opening 53 penetrating through the rear side member 52. The communication opening 53 causes the ventilation space 50S to communicate with a vehicle compartment. The rear side member 52 includes a vent duct 54 provided to the communication opening 53. While an air pressure in the vehicle compartment is stable, the vent duct 54 blocks the communication opening 53. When the air pressure in the vehicle compartment increases, the vent duct 54 acts in a direction of the arrow and air in the vehicle compartment flows out of the vehicle compartment through the ventilation space 50S.

A sound-absorbing device 10 for a vehicle is disposed in the ventilation space 50S. The sound-absorbing device 10 is an integrated resin molded member. A material constituting the sound-absorbing device 10 is, for example, polypropylene, ABS, or polycarbonate. The sound-absorbing device 10 includes a shield plate 10M and a sound-absorbing structure 11.

The shield plate 10M is fixed to the rear bumper 51 via adhesive layers 61. The shield plate 10M is supported by the rear side member 52 via an elastic member 62. The shield plate 10M divides the ventilation space 50S into a first space 50S1 in which the vent duct 54 is disposed and a second space 50S2 other than the first space 50S1.

The first space 50S1 communicates with the vehicle compartment via the vent duct 54. The first space 50S1 communicates with the outside of the vehicle compartment. Abnormal noise, such as road noise, generated at a lower side of the vehicle enters the first space 50S1 from the lower side of the vehicle. The second space 50S2 is defined by such as a rear combination lamp.

[Sound-Absorbing Device 10]

As illustrated in FIG. 2, the shield plate 10M includes a plate body 12, an outer peripheral wall 13, and a plurality of inner peripheral walls 14. The shield plate 10M includes a front end 10F and a rear end 10B. The shield plate 10M has an oval-plate shape extending in a front-rear direction of the vehicle from the front end 10F toward the rear end 10B.

The outer peripheral wall 13 is integral with an edge, which faces the rear bumper 51, of a periphery of the shield plate 10M. The outer peripheral wall 13 has a strip shape extending along the edge of the shield plate 10M. The outer peripheral wall 13 protrudes upward and downward of the vehicle from the edge of the shield plate 10M.

The inner peripheral walls 14 are integral with an edge, which faces the rear side member 52, of the periphery of the shield plate 10M. The inner peripheral walls 14 each have a strip shape extending along the edge of the shield plate 10M. The inner peripheral walls 14 align at intervals along the edge of the shield plate 10M. The inner peripheral walls 14 protrude above and below the vehicle from the edge of the shield plate 10M.

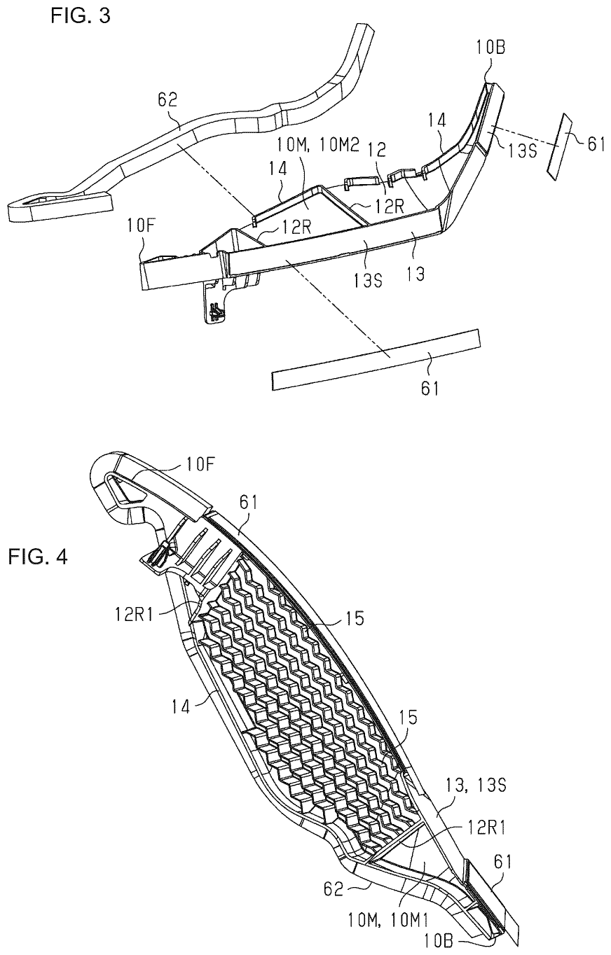

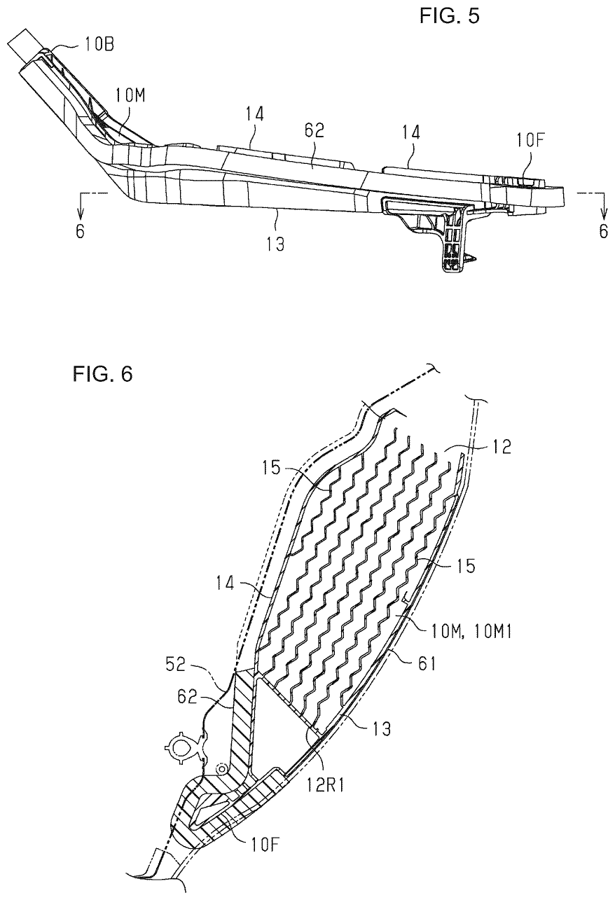

As illustrated in FIGS. 3 and 5, the plate body 12 has a shape warped upward from the front end 10F toward the rear end 10B. The plate body 12 includes a first face 10M1 (see FIG. 4) and a second face 10M2 (see FIGS. 2 and 3). The first face 10M1 faces the first space 50S1. The second face 10M2 faces the second space 50S2. The plate body 12 includes a plurality of ventilation holes 12H penetrating from the first face 10M1 to the second face 10M2.

As illustrated in FIGS. 2 and 3, the second face 10M2 includes two second reinforcing ribs 12R. The second reinforcing ribs 12R protrude upward from the second face 10M2. An amount that the second reinforcing ribs 12R each protrude from the second face 10M2 is approximately equal to an amount that the outer peripheral wall 13 protrudes from the second face 10M2, and to an amount that the inner peripheral walls 14 each protrude from the second face 10M2. The second reinforcing ribs 12R each have a straight-line shape extending in a left-right direction intersecting the front-rear direction from a viewpoint facing the second face 10M2. One second reinforcing rib 12R is positioned approximately in the center of the second face 10M2 in the front-rear direction. The other second reinforcing rib 12R is positioned between one second reinforcing rib 12R and the front end 10F. The second reinforcing ribs 12R are connected to the outer peripheral wall 13 and the inner peripheral walls 14.

As illustrated in FIG. 3, the two adhesive layers 61 are bonded to outer faces 13S of the outer peripheral wall 13. The outer faces 13S of the outer peripheral wall 13 are fixed to the rear bumper 51 via the adhesive layers 61. The elastic member 62 has a shape following the inner peripheral walls 14. The elastic member 62 is sandwiched between the inner peripheral walls 14 and the rear side member 52. The adhesive layers 61 are, for example, double-sided tape. A material constituting the elastic member 62 is, for example, ethylene-propylene rubber or an urethane pad.

The sound-absorbing device 10 is swingably supported relative to the rear side member 52 with the outer peripheral wall 13 as a fixed end. The sound-absorbing device 10 is swingable between the rear bumper 51 and the rear side member 52, which thus reduces a load to the sound-absorbing device 10 generated by vibration of the rear bumper 51 and the rear side member 52.

### [Sound-Absorbing Structure 11]

As illustrated in FIG. 4, the shield plate 10M includes two first reinforcing ribs 12R1 on the first face 10M1, and the sound-absorbing structure 11 composed of eight sound-absorbing plates 15. The first reinforcing ribs 12R1 are disposed on the first face 10M1 such that the two first reinforcing ribs 12R1 sandwich the center of the plate body 12 in the front-rear direction. The two first reinforcing ribs 12R1 increase rigidity of the plate body 12 other than the center of the plate body 12 in the front-rear direction.

The sound-absorbing structure 11 is disposed on the first face 10M1 such that the sound-absorbing structure 11 contains the center of the first face 10M1 in the front-rear direction. The sound-absorbing structure 11 is disposed on the first face 10M1 such that the sound-absorbing structure 11 contains a portion of the first face 10M1 having the greatest width in the left-right direction. The sound-absorbing structure 11 is disposed on a portion of the plate body 12 where the rigidity is not enhanced by the first reinforcing ribs 12R1 and where the width is wide in the left-right direction. The sound-absorbing structure 11 is disposed on a portion of the plate body 12 that tends to easily vibrate.

The first reinforcing ribs 12R1 protrude downward from the first face 10M1. An amount that the first reinforcing ribs 12R1 each protrude from the first face 10M1 is approximately equal to an amount that the outer peripheral wall 13 protrudes from the first face 10M1 in the vicinity of the outer peripheral wall 13. The amount that the first reinforcing ribs 12R1 each protrude from the first face 10M1 is approximately equal to an amount that the inner peripheral wall 14 protrudes from the first face 10M1 in the vicinity of the inner peripheral wall 14. The amount that the first reinforcing ribs 12R1 each protrude from the first face 10M1 gradually increases from the outer peripheral wall 13 toward the inner peripheral wall 14.

The first reinforcing ribs 12R1 each have a straight-line shape extending in the left-right direction intersecting the front-rear direction from a viewpoint facing the first face 10M1. One first reinforcing rib 12R1 is positioned on the side of the front end 10F rather than the center of the first face 10M1 in the front-rear direction. The other first reinforcing rib 12R1 is positioned on the side of the rear end 10B rather than the center of the first face 10M1 in the front-rear direction. The first reinforcing ribs 12R1 are connected to the outer peripheral wall 13 and the inner peripheral wall 14.

As illustrated in FIG. 6, the sound-absorbing structure 11 is composed of eight sound-absorbing plates 15. The sound-absorbing plates 15 align in the left-right direction intersecting the front-rear direction. The sound-absorbing plates 15 are disposed over almost the entire first face 10M1 in the left-right direction.

The sound-absorbing plates 15 extend from one first reinforcing rib 12R1 to the other first reinforcing rib 12R1 (see FIG. 4). The sound-absorbing plates 15 each have a continuous wavy shape in the front-rear direction from a viewpoint facing the first face 10M1. The sound-absorbing structure 11 includes the sound-absorbing plates 15 connected to the two first reinforcing ribs 12R1. The sound-absorbing structure 11 includes sound-absorbing plates 15 connected to the inner peripheral wall 14 at both ends in the front-rear direction, and a sound-absorbing plate 15 connected to the outer peripheral wall 13 at both ends in the front-rear direction.

In the left-right direction intersecting the front-rear direction, mutually adjacent sound-absorbing plates 15 are parallel to each other. The period of the wavy shape of the sound-absorbing plates 15 in the front-rear direction is approximately equal to the interval between mutually adjacent sound-absorbing plates 15 in the left-right direction. The structure of one angle shape in the wavy shapes of the sound-absorbing plates 15 is repeated periodically in the front-rear and left-right directions over almost the entire area sandwiched between the two first reinforcing ribs 12R1.

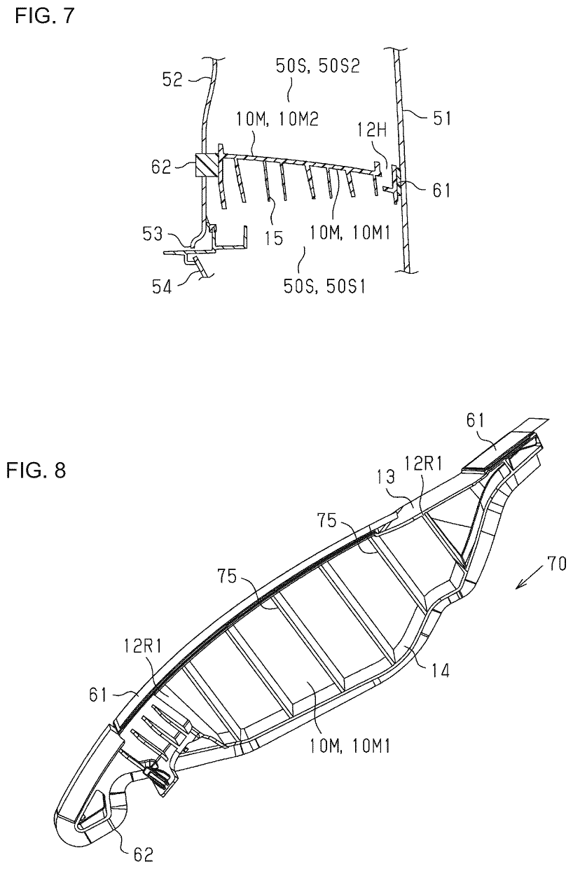

As illustrated in FIG. 7, the sound-absorbing plates 15 protrude downward from the first face 10M1. An amount that the sound-absorbing plates 15 each protrude from the first face 10M1 is approximately equal to the amount that the outer peripheral wall 13 protrudes from the first face 10M1 in the vicinity of the outer peripheral wall 13. The amount that the sound-absorbing plates 15 each protrude from the first face 10M1 is approximately equal to the amount that the inner peripheral wall 14 protrudes from the first face 10M1 in the vicinity of the inner peripheral wall 14. In the same manner as in the first reinforcing ribs 12R1, an amount that the sound-absorbing plates 15 each protrude from the first face 10M1 gradually increases from the outer peripheral wall 13 toward the inner peripheral wall 14.

Thicknesses of the sound-absorbing plates 15 in the left-right direction gradually decrease from the first face 10M1 toward the tips of the sound-absorbing plates 15. The thickness of each sound-absorbing plate 15 in the left-right direction gradually decreases, for example, from 1.2 mm to 0.8 mm. The thickness of each sound-absorbing plate 15 in the left-right direction is less than or equal to a thickness of the plate body 12. Tapered shapes of the sound-absorbing plates 15 allow a mold for forming the sound-absorbing structure 11 to be easily pulled out from the base to the tips of the sound-absorbing plate 15.

In this manner, the shield plate 10M divides the ventilation space 50S into the first space 50S1 and the second space 50S2. The sound-absorbing device 10 for a vehicle constitutes a resonance system composed of a spring and a mass. The sound-absorbing structure 11 protruding from the shield plate 10M toward the first space 50S1 functions as the mass of the resonance system. The rigidity of the shield plate 10M, the rigidity of the sound-absorbing structure 11, and elasticity of air in the second space 5082 function as the spring of the resonance system.

When sound having the same frequency as resonance frequency strikes the sound-absorbing device 10 in the first space 50S1, the sound-absorbing device 10 vibrates and the vibration energy is converted into thermal energy through friction loss in the shield plate 10M and the sound-absorbing structure 11. This causes sound absorption by the sound-absorbing device 10 for a vehicle, and the sound-absorbing structure 11 increases the mass of the resonance system and suppresses fluctuations of the resonance frequency. In addition, abnormal noise, such as road noise, generated from the lower side of a vehicle collides with abnormal noise reflected by the shield plate 10M, which thus cancels the abnormal noise and reduces the abnormal noise transmitting from the communication opening 53 to the inside of the vehicle compartment. As a result, the sound-absorbing device 10 disposed on the side of the communication opening 53 corresponding to the second space 50S2 reduces a volume occupied by the sound-absorbing device 10 around the communication opening 53 while obtaining a sound-absorbing effect, as compared to the sound-absorbing device 10 disposed along a periphery of the communication opening 53.

### [Sound Transmission Loss]

Next, an operation of the sound-absorbing device 10 will be described with reference to FIGS. 8 and 9. FIG. 8 illustrates a perspective structure of a sound-absorbing device 70. FIG. 9 illustrates a calculation result of sound transmission loss of the sound-absorbing device 10 described with FIGS. 2 to 7 as Test Example 1. In addition, FIG. 9 illustrates a calculation result of sound transmission loss of the sound-absorbing device 70 illustrated in FIG. 8 as Test Example 2. It should be noted that the sound-absorbing device 70 used in the calculation of the sound transmission loss includes a different structure of the sound-absorbing plates 15 from that of the sound-absorbing device 10, but includes the same other structures as in the sound-absorbing device 10. In the following, configurations of the sound-absorbing device 70 that differ from those of the sound-absorbing device 10 will be mainly described, and duplicate description of configurations common to the sound-absorbing device 10 will be omitted.

As illustrated in FIG. 8, the sound-absorbing device 70 includes five sound-absorbing plates 75. The sound-absorbing plates 75 extend from the outer peripheral wall 13 to the inner peripheral wall 14. The sound-absorbing plates 75 each have a continuous straight-line shape in the left-right direction from a viewpoint facing the first face 10M1. The five sound-absorbing plates 75 are disposed at the same intervals in the front-rear direction between the two first reinforcing ribs 12R1. The mutually adjacent sound-absorbing plates 75 in the front-rear direction are parallel to each other.

The sound-absorbing plates 75 protrude downward from the first face 10M1. An amount that the sound-absorbing plates 75 each protrude from the first face 10M1 is approximately equal to the amount that the outer peripheral wall 13 protrudes from the first face 10M1 in the vicinity of the outer peripheral wall 13. The amount that the sound-absorbing plates 75 each protrude from the first face 10M1 is approximately equal to the amount that the inner peripheral wall 14 protrudes from the first face 10M1 in the vicinity of the inner peripheral wall 14. In the same manner as in the first reinforcing ribs 12R1, the amount that the sound-absorbing plates 75 each protrude from the first face 10M1 gradually increases from the outer peripheral wall 13 toward the inner peripheral wall 14.

Thicknesses of the sound-absorbing plates 75 in the front-rear direction gradually decrease from the first face 10M1 toward the tips of the sound-absorbing plates 75. The thickness of each sound absorbing plate 75 in the front-rear direction is less than or equal to the thickness of the plate body 12 in the same manner as in the thickness of each sound-absorbing plate 15 in the left-right direction.

FIG. 9 illustrates calculation results of sound transmission loss at frequencies from 200 Hz to 4000 Hz, obtained with an acoustic analysis software. The sound transmission loss in Test Example 1 was obtained from a structural mesh in accordance with the structure of the sound-absorbing device 10 and from an oval-cylindrical shaped acoustic mesh extending in a vertical direction that encircles the sound-absorbing device 10. The sound transmission loss in Test Example 2 was obtained from a structural mesh in accordance with the structure of the sound-absorbing device 70 and from the same oval-cylindrical shaped acoustic mesh as in Test Example 1. In this test, a sound-input surface mesh was set in the first space 50S1 of the sound-absorbing device 10, and a sound-radiation surface mesh was set in the second space 50S2 of the sound-absorbing device 10. The sound transmission loss in Test Example 1 was then calculated from input power at the sound-input surface mesh and radiation power at the sound-radiation surface mesh. A sound-input surface mesh was set in the first space 50S1 of the sound-absorbing device 70 and a sound-radiation surface mesh was set in the second space 50S2 of the sound-absorbing device 70, and calculation was performed from a ratio between input power at the sound-input surface mesh and radiation power at the sound-radiation surface mesh.

As illustrated in FIG. 9, the sound transmission loss in Test Example 1 includes one peak around 800 Hz illustrating the highest sound transmission loss. The sound transmission loss in Test Example 1 includes a broad peak around 1600 Hz illustrating a lower sound transmission loss than the peak around 800 Hz. In contrast, the sound transmission loss in Test Example 2 includes no peak around 800 Hz and includes a broad peak only around 1600 Hz. These results have confirmed that sound-absorbing effects can be obtained by the sound-absorbing devices 10, 70. It has also been confirmed that the sound-absorbing structure 11 composed of the sound-absorbing plates 15 illustrates a higher sound-absorbing effect than that of the sound-absorbing plates 75.

As described above, the following effects can be obtained according to the above embodiments.

(1) The sound-absorbing structure 11 protruding from the shield plate 10M into the first space 50S1 reduces the volume occupied by the sound-absorbing devices 10, 70 around the communication opening 53, compared to the sound-absorbing device 10 disposed along the periphery of the communication opening 53, while providing the sound-absorbing effect.

(2) The sound-absorbing structure 11 is composed of the sound-absorbing plates 15, 75, which thus makes it possible to change the mass of the resonance system by changing the number of the sound-absorbing plates 15, 75. Therefore, the sound-absorbing devices 10, 70 for a vehicle enable the resonance frequency to be easily adjusted to the frequency of sound that reaches the vehicle compartment, which thus makes it easier to achieve suitable sound absorption.

(3) In the above embodiment illustrated in FIGS. 1 to 7, the sound-absorbing plates 15 each have a wavy shape extending in a longitudinal direction of the shield plate 10M. This configuration has a higher sound-absorbing effect than that of the sound-absorbing plates 75 extending in the left-right direction. In addition, this configuration makes it possible to change the rigidity of the sound-absorbing plates 15 over a wide range. Therefore, the sound-absorbing device 10 for a vehicle enables the resonance frequency to be easily adjusted to the frequency of sound that reaches the vehicle compartment, which thus makes it easier to achieve suitable sound absorption.

(4) In the above embodiment, the shield plate 10M can swing between the rear bumper 51 and the rear side member 52. This configuration makes it possible to reduce a load on the shield plate 10M generated by vibration of the rear bumper 51 or the rear side member 52.

(5) In the above embodiment, the shield plate 10M and the sound-absorbing plates 15 are reinforced by the first reinforcing ribs 12R1. This configuration enhances durability of the sound-absorbing device 10, and the sound-absorbing effect by the sound-absorbing device 10 continues for a long time.

The above embodiment may be modified as below and implemented.

### [Sound-Absorbing Plates 15, 75]

The sound-absorbing devices 10, 70 may be omitted from the first reinforcing ribs 12R1. In this case, the sound-absorbing plates 15, 75 may be supported only by the first face 10M1.

The sound-absorbing plates 15, 75 may be disposed on the first face 10M1 so as to be separated from at least one of the two first reinforcing ribs 12R1.

The sound-absorbing plates 15, 75 may be disposed on the first face 10M1 such that the sound-absorbing plates 15, 75 are crossed by the first reinforcing ribs 12R1. In this case, the sound-absorbing plates 15, 75 may be disposed such that at least one of the two ends of the sound-absorbing plates 15, 75 in the front-rear direction is separated from the first reinforcing ribs 12R1.

The sound-absorbing plates 15, 75 may contain sound-absorbing plates 15, 75 that have mutually different thicknesses. The sound-absorbing plates 15, 75 may contain sound-absorbing plates 15, 75 that protrude from the first face 10M1 in mutually different amounts. The sound-absorbing plates 15, 75 may contain sound-absorbing plates 15, 75 that have mutually different lengths in the extending directions of the sound-absorbing plates 15, 75. In other words, sound-absorbing elements, such as the sound-absorbing plates 15, 75, may differ from each other in the sound-absorbing structure 11.

### [Sound-Absorbing Structure 11]

The sound-absorbing structure 11 may have a plate shape protruding from the first face 10M1 into the first space 50S1, and may have a honeycomb pattern of laid-out regular polygons from a viewpoint facing the first face 10M1.

The sound-absorbing structure 11 may include a Helmholtz structure with a cylindrical shape protruding from the first face 10M1 into the first space 50S1. In this case, from a viewpoint facing the first face 10M1, the sound-absorbing structure 11 may be composed of Helmholtz structures laid on the first face 10M1 or may include Helmholtz structures scattered over the first face 10M1.

The sound-absorbing structure 11 may have conical shapes protruding from the first face 10M1 into the first space 50S1. In this case, from a viewpoint facing the first face 10M1, the sound-absorbing structure 11 may be composed of conical shapes laid on the first face 10M1, or conical shapes scattered over the first face 10M1.

### [Shield Plate 10M]

The shield plate 10M may be supported by the rear bumper 51 via the elastic member 62 instead of the adhesive layer 61. The shield plate 10M may be fixed to the rear side member 52 via the adhesive layer 61 instead of the elastic member 62. In other words, either the vehicle interior or the vehicle exterior is a first exterior, and the vehicle interior or the vehicle exterior other than the first exterior is a second exterior. The shield plate 10M may be connected to the first and second exteriors via an adhesive material or via an elastic member. Alternatively, the shield plate 10M may be connected to the first exterior via the adhesive material and to the second exterior via the elastic member.

The shield plate 10M may be separated from the sound-absorbing structure 11. If the shield plate 10M is separated from the sound-absorbing structure 11, it is possible to reduce manufacturing constraint on the structure of the sound-absorbing structure 11, as compared to a case where the shield plate 10M and the sound-absorbing structure 11 are integrated. In contrast, if the shield plate 10M and the sound-absorbing structure 11 are integrated, it is possible to suppress an increase in the number of members of the sound-absorbing device 10 and also reduce cost for the sound absorption in the ventilation space 50S.

### [Ventilation Space 50S]

The sound-absorbing device 10 may be disposed above the communication opening 53 in the ventilation space 50S. The sound-absorbing device 10 may be disposed below the communication opening 53 in the ventilation space 50S.

An upper end of the ventilation space 50S may be divided by, such as a rear combination lamp, or may communicate with the vehicle compartment. In this case, the first space 50S1 may communicate only with the outside of the vehicle and the second space 50S2 may communicate with the vehicle compartment. The ventilation space 50S may be any space for communication between the vehicle compartment and the outside of the vehicle, and the vent duct 54 may be omitted from the rear side member 52.

1. A vehicle sound-absorbing device configured to be disposed in a ventilation space between a vehicle exterior and a vehicle interior, the vehicle interior having a communication opening through which the ventilation space communicates with a vehicle compartment, the vehicle sound-absorbing device comprising:
a shield plate configured to be connected to the vehicle exterior and the vehicle interior and thus divide the ventilation space into a first space in which the communication opening is disposed and a second space other than the first space; and
a sound-absorbing structure protruding from a first face of the shield plate toward the first space, the first face facing the first space.

2. The vehicle sound-absorbing device according to claim 1, wherein
the shield plate has a shape extending in a front-rear direction of the vehicle;
the sound-absorbing structure includes a plurality of sound-absorbing plates aligned in a direction intersecting the front-rear direction; and
the sound-absorbing plates each have a continuous wavy shape in the front-rear direction from a viewpoint facing the first face.

3. The vehicle sound-absorbing device according to claim 1, wherein
either the vehicle interior or the vehicle exterior is a first exterior,
the vehicle interior or the vehicle exterior other than the first exterior is a second exterior, and
the shield plate is fixed to the first exterior swingably relative to the second exterior.

4. The vehicle sound-absorbing device according to claim 1, wherein
either the vehicle interior or the vehicle exterior is a first exterior,
the vehicle interior or the vehicle exterior other than the first exterior is a second exterior, and
the shield plate is fixed to the first exterior through an adhesive layer and supported by the second exterior via an elastic member.

5. The vehicle sound-absorbing device according to claim 2, wherein
the shield plate includes a reinforcing rib protruding from the first face toward the first space,
the reinforcing rib has a straight-line shape extending in a direction intersecting the front-rear direction from a viewpoint facing the first face, and
the plurality of sound-absorbing plates includes the sound-absorbing plates connected to the reinforcing rib.

6. The vehicle sound-absorbing device according to claim 5, wherein
the shield plate includes two reinforcing ribs protruding from the first face toward the first space,
the reinforcing ribs each have a straight-line shape extending in a direction intersecting the front-rear direction and align in the front-rear direction, from a viewpoint facing the first face, and
the plurality of sound-absorbing plates is disposed between the two reinforcing ribs and includes the sound-absorbing plate connected to the two reinforcing ribs.

7. The vehicle sound-absorbing device according to claim 1, wherein the shield plate and the sound-absorbing structure are integral.
